(19) United States
(12) Patent Application Publication
(10) Pub. No.: US 2011/0147038 A1
(43) Pub. Date: Jun. 23, 2011

(54) OXIDATION-RESISTANT HIGH TEMPERATURE WIRES AND METHODS FOR THE MAKING THEREOF

(75) Inventors: Richard Fox, Mesa, AZ (US); Mark Kaiser, Prospect Heights, IL (US); Robert Franconi, New Hartford, CT (US)

(73) Assignee: HONEYWELL INTERNATIONAL INC., Morristown, NJ (US)

(21) Appl. No.: 12/640,711

(22) Filed: Dec. 17, 2009

(51) Int. Cl. H01B 7/18; B05D 5/12

(52) U.S. Cl. 174/102 C; 427/118

(57) ABSTRACT

Embodiments of an oxidation-resistant high temperature wire are provided. In one embodiment, the oxidation-resistant high temperature wire includes an elongated core formed from a first material, an electrically conductive sheathing disposed around the elongated core and formed from a second material, and a high temperature dielectric coating formed around the electrically conductive sheathing. The second material has an electrical conductivity greater than the electrical conductivity of the first material, while the first material has a tensile strength greater than the tensile strength of the second material.

### TECHNICAL FIELD

The present invention relates generally to insulated wires and, more particularly, to oxidation-resistant wires well-suited for use within high temperature environments, as well as to methods for forming such wires.

### BACKGROUND

Many electromagnetic devices, including various sensors, motors, and actuators employ one or more coils of insulated wires. Each insulated wire typically includes an elongated conductor sheathed within an insulative coating. In low temperature applications, the elongated conductor is commonly formed from copper due to its relatively low cost, low resistivity, and high ductility. However, in high temperature applications (e.g., characterized by temperatures exceeding approximately 240° C.), the outer surface of the copper wire can oxidize over time, decreasing conductor's conductivity, reducing the conductor's tensile strength, and increasing the conductor's brittleness. Although the conductor's oxidative stability can be significantly increased by forming the conductor from nickel, the resistivity of nickel is significantly greater than that of copper. As a result, high temperature wires employing nickel conductors are generally unsuitable for utilization in high temperature applications requiring lower resistivity conductors and, specifically, for use within certain airborne sensors (e.g., variable differential transformers) and actuators (e.g., solenoids and motors) deployed aboard aircraft.

In an attempt to overcome the above-noted limitations, high temperature wire has been developed and commercially introduced that employs a relatively pure copper conductor clad with nickel. Advantageously, the nickel cladding helps protect the highly conductive copper conductor from oxidation in high temperature operating environments. Oxidation of the nickel clad copper wire can still occur, however, if imperfections exist in the wire's nickel cladding, if there is an insufficient quantity of nickel relative to copper (e.g., if the by-weight percentage of the nickel cladding is too low), or if the copper is oxidized prior to cladding. Oxidation of improperly prepared or damaged nickel clad copper wire can occur over time and, consequently, may not be visible until failure of the wire has occurred. The industry has termed failure of this type “the red plague” due to the red coloration exhibited by conventional high temperature wires after the oxidation of the conductor.

Considering the above, there exists an ongoing need to provide embodiments of an insulated wire that is resistant to oxidation and suitable for utilization within high temperature operating environments (e.g., characterized by temperatures exceeding approximately 240° C.). Ideally, embodiments of such an oxidation-resistant high temperature wire would exhibit relatively low resistivity and would consequently be well-suited for utilization within high temperature sensors (e.g., linear variable differential transformers) and actuators (e.g., solenoids or motors) of the type commonly deployed aboard aircraft or utilized within other harsh environments with extreme thermal exposure. It would also be desirable to provide embodiments of a method for manufacture of such an oxidation-resistant high temperature wire. Other desirable features and characteristics of the present invention will become apparent from the subsequent Detailed Description and the appended Claims, taken in conjunction with the accompanying Drawings and the foregoing Background.

### BRIEF SUMMARY

Embodiments of an oxidation-resistant high temperature wire are provided. In one embodiment, the oxidation-resistant high temperature wire includes an elongated core formed from a first material, an electrically conductive sheathing disposed around the elongated core and formed from a second material, and a high temperature dielectric coating formed around the electrically conductive sheathing. The second material has an electrical conductivity greater than the electrical conductivity of the first material, while the first material has a tensile strength greater than the tensile strength of the second material.

Embodiments of a method for manufacturing an oxidation-resistant high temperature wire are also provided. In one embodiment, the method includes the steps of: (i) forming an elongated core from a first material, (ii) forming an electrically conductive sheathing from a second material around the elongated core, and (iii) applying a high temperature dielectric coating around the electrically conductive sheathing. The second material has an electrical conductivity greater than the electrical conductivity of the first material, and the first material has a tensile strength greater than the tensile strength of the second material.

### BRIEF DESCRIPTION OF THE DRAWINGS

At least one example of the present invention will hereinafter be described in conjunction with the following figures, wherein like numerals denote like elements, and:

FIG. 1 is a flowchart illustrating a method suitable for producing an oxidation-resistant high temperature insulated wire in accordance with an exemplary embodiment of the present invention; and

FIG. 2 is a generalized cross-sectional view of an exemplary oxidation-resistant high temperature wire that may be produced utilizing the exemplary process illustrated in FIG. 1.

### DETAILED DESCRIPTION

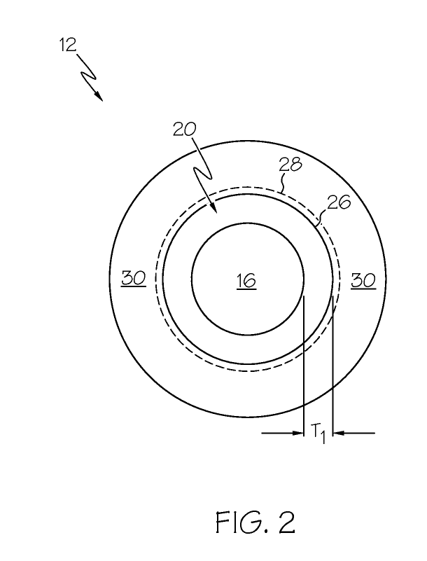

The following Detailed Description is merely exemplary in nature and is not intended to limit the invention or the application and uses of the invention. Furthermore, there is no intention to be bound by any theory presented in the preceding Background or the following Detailed Description. As utilized herein, the terms “over” and “around” are utilized to indicate relative disposition only and do not indicate whether direct physical contact exists between the named structural elements. Thus, as an example, a dielectric coating may be formed over or around an electrically conductive sheathing without necessary being in contact therewith due to the provision of one or more intervening annular layers, such adhesion layer 28 described below in conjunction with FIG. 2.

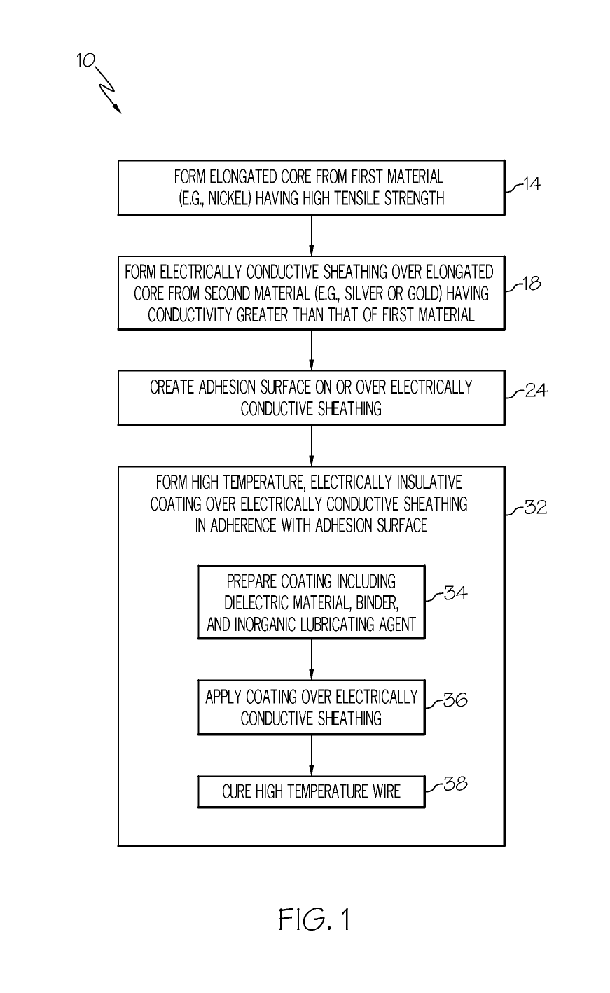

FIG. 1 is a flowchart illustrating an exemplary method 10 suitable for producing an oxidation-resistant high temperature insulated wire, and FIG. 2 is a generalized cross-sectional view of an insulated wire 12 that may be produced utilizing the exemplary method illustrated in FIG. 1. To commence method 10 (STEP 14, FIG. 1), an elongated core, such as core 16 shown in FIG. 2, is formed from a first material having a high tensile strength. As appearing herein, the term “high tensile strength” is utilized in a relative sense to indicate that the first material has a tensile strength greater than, and preferably at least twice, the tensile strength of the material subsequently utilized to form an electrically conductive sheathing 20 around elongated core 16, as described in more detail below. In many embodiments, elongated core 16 (FIG. 2) is formed from a material having a tensile strength exceeding approximately 800 megapascal. In addition to having a relatively high tensile strength, it is desirable for the selected core material to be oxidatively stable and, specifically, less prone to oxidation in high temperature environments (e.g., characterized by temperatures exceeding 240° C.) than is copper. It is also desirable for elongated core 16 to be formed from a material that is electrically conductive, although the electrical resistivity of the core material will typically be greater than the resistivity of the material from which the electrically conductive sheathing 20 is formed, as described below. Given these criteria, and other considerations (e.g., material cost), it is generally preferred that elongated core 16 is formed from a nickel having a purity exceeding approximately 99.9% and, more preferably, exceeding approximately 99.99%. Notably, the tensile strength of nickel, when formed into elongated core 16 utilizing conventional fabrication techniques (e.g., drawing through progressively smaller dies and subsequent annealing), is approximately 827 megapascal, while the tensile strength of copper is approximately 207 megapascal. This preference notwithstanding, elongated core 16 can be formed from other materials including, but not limited to, platinum (tensile strength≈379 megapascal).

Continuing with exemplary method 10 (FIG. 1), an electrically conductive sheathing 20 (FIG. 2) is next formed around elongated core 16 (STEP 18, FIG. 1). Electrically conductive sheathing 20 is preferably formed from a second material having an electrical conductivity at least twice the electrical conductivity of the material utilized to form elongated core 16 or, stated differently, an electrical resistivity equal to or less than half that of the core material. It is also preferred that the selected sheathing material has a relatively high oxidation stability and is consequently resistive to oxidation when utilized within high temperature operating environments (e.g., again, characterized by temperatures exceeding 240° C.). In addition, the sheathing material may be selected based upon chemical compatibility with the material utilized to form elongated core 16. In a first embodiment, electrically conductive sheathing 20 is formed from silver having a relatively high purity; e.g., exceeding approximately 99.9% and, preferably, exceeding approximately 99.99%. In a second embodiment, electrically conductive sheathing 20 is formed from gold having a purity exceeding approximately 99.9% and, preferably, exceeding approximately 99.99%. The resistivity of silver and gold is approximately 1.62 and 2.44 microhms-centimeter, respectively. By comparison, the resistivity of copper is approximately 1.72 microhms-centimeter. The foregoing list of examples notwithstanding, it is generally preferred that electrically conductive sheathing 20 is formed from a silver having a purity greater than approximately 99.99% to impart the desired electrical characteristics (e.g., relatively low resistivity) to high temperature wire 12, and that elongated core 16 is formed from a nickel having a purity greater than approximately 99.99% to impart the desired tensile strength to high temperature wire 12; such a combination of materials (i.e., a nickel core surrounded by a conductive silver sheathing) was reduced to practice and found to meet or exceed all desired parameters (e.g., desired flexibility and dielectric coating adhesion properties), as described more fully below.

In embodiments wherein oxidation-resistant high temperature wire 12 is to be utilized within an electromagnetic sensor (e.g., variable differential transformer) having a signal output that can be materially effected by fluctuations in the magnetic characteristics of wire 12, the material utilized to form electrically conductive sheathing 20 is preferably chosen to have a relatively low magnetic susceptibility; e.g., between approximately −19.5×10-6 centimeter-gram-second (cgs) and approximately −5.46×10-6 cgs. By selecting a sheathing material having a relatively low magnetic susceptibility, any effect on the electromagnetic sensor's output will be minimized should the temperature of sheathing 20 surpass the material's curie temperature during operation. Of course, in embodiments wherein fluctuations in the magnetic susceptibility of high temperature wire 12 (FIG. 2) have little effect on the operation of the electromagnetic device, or in embodiments wherein the electromagnetic device is exclusively operated in a temperature range above or beneath the curie temperature of material utilized to form electrically conductive sheathing 20, the magnetic susceptibility of the selected sheathing material is less of a concern.

During STEP 18 of method 10 (FIG. 1), electrically conductive sheathing 20 is applied around elongated core 16 to a predetermined thickness (identified in FIG. 2 as thickness “T₁”). The thickness of electrically conductive sheathing 20 (T₁) will inevitably vary amongst different embodiments of high temperature wire 12. It is noted, however, that electrically conductive sheathing 20 and elongated core 16 function as parallel resistors when current flows through high temperature wire 12. The thickness of electrically conductive sheathing 20 may thus be determined, at least in part, as a function of desired current flow through high temperature wire 12. More specifically, given a desired current flow, the thickness of sheathing 20 can be back calculated utilizing well-established electrical equations (e.g., Ohm's law) and known parameters of high temperature wire 12, such as the diameter or gauge of elongated core 16, the resistivity of the chosen core material, the resistivity of the chosen sheathing material, and the estimated voltage differential to be applied across wire 12. The thickness of sheathing 20 may also be determined based at least partially upon whether high temperature wire 12 will conduct a direct current (DC) or an alternating current (AC) during operation. AC current flow will typically be concentrated within the outer annular portion of electrically insulative sheathing 20. Conversely, DC current flow will typically be more evenly distributed across the body of electrically conductive sheathing 20. Consequently, to achieve a desired resistance, sheathing 20 may be applied to a lesser thickness (relative to the diameter of core 16) for AC applications than for DC applications. To provide one generalized and non-limiting example, electrically conductive sheathing 20 may be formed to have a thickness between approximately 20% and approximately 40% of the cumulative cross-sectional area of sheathing 20 and elongated core 16.

Electrically conductive sheathing 20 can be applied around elongated core 16 utilizing any one of a number of conventionally-known techniques, including sputter coating, electrolysis, and vapor deposition techniques. In embodiments wherein the desired thickness of electrically conductive sheathing 20 is relatively thick, a cladding process wherein elongated core 16 is drawn through a series of mandrels or dies having successively decreasing bore sizes is conveniently utilized to apply sheathing 20 around core 16. By comparison, in embodiments wherein the desired thickness of electrically conductive sheathing 20 is relatively thin, a sputter coating or plating process (e.g., electroplating or electroless plating) may be utilized to apply electrically conductive sheathing 20 around elongated core 16. In either case, electrically conductive sheathing 20 may be applied in multiple successive coatings. If desired, one or more cleaning steps may be performed prior to application of sheathing 20 around elongated core 16; e.g., elongated core 16 may be treated with a degreasing agent to remove any grease or oils present on the outer surface of core 16 prior to the application of the sheathing material.

Advancing to STEP 24 of exemplary method 10 (FIG. 1), an adhesion surface is next created on or over electrically conductive sheathing 20 to increase the adherence of a subsequently-applied dielectric coating 30, as described below. In a first embodiment, an adhesion surface 26 (FIG. 2) is formed directly on the exterior of electrically conductive sheathing 20 via a thermal or chemical oxidation process. More specifically, electrically conductive sheathing 20 may be subject to a calcination process (e.g., exposure to temperatures approaching or exceeding approximately 800° C. for a predetermined period of time) to form an oxide shell on the conductor's exterior surface. In a second embodiment, the adhesion surface is not formed directly on electrically conductive sheathing 20, but is instead formed over and around sheathing 20 via the application of an adhesion layer 28 (shown in phantom in FIG. 2). The application of a separately-applied adhesion layer 28 is typically desirable when electrically conductive sheathing 20 is formed from a material, such as gold, around which an oxide shell cannot easily be grown. In one specific embodiment wherein electrically conductive sheathing 20 is formed from gold, adhesion layer 28 is formed over sheathing 20 via the plating of one or more of the following materials: silver, platinum, nickel, or aluminum.

Finally, during STEP 32 of exemplary method 10 (FIG. 2), a high temperature dielectric coating 30 is formed around electrically conductive sheathing 20. Dielectric coating 30 is preferably formed in adhesion with the adhesion surface 26, 28 previously formed on or over electrically conductive sheathing 20 as previously described. Dielectric coating 30 may include any electrically insulative material or combination of materials capable of maintaining structural integrity and insulative properties within high temperature operating environments of the type described above. As one example, dielectric coating 30 may include a silicon oxide; however, silicon oxide insulated wires are relatively inflexible, which renders such wires difficult to utilize in electromagnetic devices wherein the wires need to be bent, coiled, or otherwise formed after application and curing of the insulative coating. In a preferred embodiment, dielectric coating 30 is both thermally stable at high temperatures (e.g., exceeding 240° C.) and sufficiently flexible to be formed into a desired shape (e.g., a coil) subsequent to application and curing of the insulative coating. To this end, the following describes a series of sub-steps (i.e., SUB-STEPS 34, 36, and 38) that can be performed during STEP 24 of method 10 (FIG. 1) to produce an exemplary electrically insulative coating 30 around electrically conductive sheathing 20 that is thermally stable at high temperatures and that is sufficiently flexible to be formed into a desired shape subsequent to application and curing of the insulative coating.

During SUB-STEP 34 of method 10 (FIG. 1), a dielectric coating is prepared. In this particular example, the dielectric coating includes at least three main components: (i) a dielectric material, (ii) a binder, and (iii) an inorganic lubricant. As utilized herein, the term “dielectric material” is defined broadly to include dielectric material or dielectric-forming materials; i.e., materials that form dielectrics when subjected to the process steps described herein. The selected dielectric material may comprise various materials having desirable insulative properties, preferably having a dielectric constant (κ) less than ten (10), and more preferably having a dielectric constant (κ) less than three (3), after curing. The selected dielectric materials should be capable of insulating the elongated conductor in high temperature operating environments exceeding, for example, 240° C. Suitable dielectric materials include, but are not limited to, alumina, silica, silica aluminate, and other inorganic oxides. These examples notwithstanding, the selected dielectric material preferably comprises zeolite.

Also, during SUB-STEP 34, an organic binder is selected. In a preferred group of embodiments, the selected binder comprises an organic component that can be substantially or completely decomposed when subjected to heat-treatment (e.g., calcination). In this case, the organic component may include at least one polymeric component with an oxygen atom. Suitable organic components include various polyolefins, such as polyvinyl alcohol and polyethylene oxide. In a preferred embodiment, the selected binder comprises an aqueous polymer blend of polyvinyl alcohol and polyethylene; e.g., water, polyvinyl alcohol, and polyethylene oxide may be present at a level of about 15% polymer by weight. Aqueous binders are generally preferred for their ability to leave little to no organic residue after calcination, for their ease of application, and for their environmentally friendly characteristics; however, other organic binders (e.g., non-aqueous polymer blends) may also be employed, such as paraffin waxes dissolved in appropriate organic solvents (e.g., acetone and toluene).

With continued reference to exemplary method 10 illustrated in FIG. 1, an inorganic lubricant is further selected during SUB-STEP 34. In one group of embodiments, the inorganic lubricant comprises an inorganic material that is substantially insulative. In a preferred group of embodiments, the inorganic lubricant comprises one or more nitrides, such as aluminum nitride, silicon nitride, titanium nitride, and/or boron nitride. In a still more preferred embodiment, the inorganic lubricant comprises boron nitride added to the dielectric material and binder in a quantity of approximately 10% to 0.01%, and more preferably approximately 1% to 0.1%, by weight of the dielectric material (e.g., zeolite). Advantageously, the addition of an inorganic lubricant to the insulative coating increases the lubricity thereof and, in so doing, decreases the likelihood of attrition due to self-abrasion. The resulting high temperature insulated wire (e.g., wire 12 shown in FIG. 2) is consequently well-suited for winding and, thus, ideal for use in coiled-wire devices, such as a solenoid or variable differential transducer of the type deployed aboard aircraft or utilized within other harsh environments with extreme thermal exposure.

The dielectric material, the organic binder, and the inorganic lubricant selected during SUB-STEP 34 (FIG. 1) may be combined into a mixture or slurry in any suitable manner. After being combined into a slurry, the slurry is preferably manipulated to obtain a desired range of particle sizes and/or a uniform consistency. In these regards, the slurry may be milled, mixed, or blended; however, it is generally preferred that the slurry be milled, such as with a ball mill, in order to achieve a substantially uniform particle size.

After preparation of the dielectric coating (SUB-STEP 34, FIG. 1), the dielectric coating is applied around electrically conductive sheathing 20 (SUB-STEP 36, FIG. 1). Application may involve spraying, brushing, slurry coating, and dip or draw coating processes. It is preferred, although by no means necessary, that the entirety of the sheathing's outer circumferential surface is covered with the dielectric coating to create a tubular insulative covering that is generally co-axial with the electrically conductive sheathing. The thickness to which the dielectric slurry is deposited may depend upon desired insulative properties, conductor gauge, intended application, and other such criteria. As a non-limiting example, if the conductor (i.e., electrically conductive sheathing 20 and elongated core 16) has a diameter of approximately 0.127 mm (5 mils), the dielectric coating may be deposited to a thickness of approximately 0.0381 mm (1.5 mils) thereby resulting in an overall increase in the insulated wire's diameter of 0.0762 mm (3 mils). If dielectric coating 30 includes an aqueous polymer blend of the type described above, the coated conductor may be dried (e.g., by exposure to a heated air stream) to remove substantially all of the water from the dielectric coating.

Next, at SUB-STEP 38 (FIG. 1), oxidation-resistant high temperature wire 12 (FIG. 2) is cured. Curing may entail exposure to an elevated temperature for a period of time sufficient to substantially decompose the organic component (or components) included within the outer surface of dielectric coating 30. For example, high temperature wire 12 may be exposed to temperatures of approximately 400° C. to 1000° C. for approximately 2 to 10 hours and, more specifically, to temperatures of approximately 600° C. to 950° C. for approximately 4 to 6 hours. Notably, due to the relatively high oxidative stability of elongated core 16 and of electrically conductive sheathing 20, high temperature wire 12 is able to withstand such high temperature calcination or curing processes without little to no oxidation. Consequently, the superior conductivity and tensile strength of high temperature wire 12 can be maintained throughout and after the high temperature curing process utilized to decompose the organic component or components of dielectric coating 30.

Curing of dielectric coating 30 results in the formation of dielectric coating 30 formed over and around electrically conductive sheathing 20. Advantageously, dielectric coating 30 is flexible (e.g., may be bent without concern of the creation of micro-fissures in the heat-treated dielectric material) and is capable of electrically insulating sheathing 20 even when subjected to elevated temperatures (e.g., exceeding 240° C.). Without intending to be bound by theory, heat-treatment of the coated conductor is believed to cause decomposition of dielectric slurry and the release of gaseous organic byproducts, such as carbon dioxide and/or carbon monoxide. The release of these gaseous organic byproducts leaves the inorganic material, from the slurry, on the conductor. This, in turn, permits the inorganic material to interface with the surface oxide of the electrically conductive sheathing or the adhesion layer, when provided, while removing carbon from the dielectric coating thus improving the insulative proprieties thereof.

The foregoing has thus provided an exemplary embodiment of an insulated wire that is resistant to oxidation and that is suitable for use within avionic and other high temperature operating environments. In the above-described exemplary embodiment, the high temperature wire has excellent conductivity, as provided by a low resistance (e.g., silver) sheathing, and excellent tensile strength, as provided by an elongated (e.g., nickel) core. As a further advantage, when produced to include the dielectric coating described above in conjunction with SUB-STEPS 34, 36, and 38 (FIG. 1), the high temperature oxidation-resistant wire may readily be formed into a desired shape (e.g., wound into a coil) after application and curing the dielectric coating. At least one exemplary embodiment of a method for manufacture of such an oxidation-resistant high temperature wire has also been provided.

An embodiment of a high temperature wire including a high tensile strength core, a low resistance sheathing, and a high temperature dielectric coating was reduced to practice. The high tensile strength core was formed from nickel having a purity exceeding approximately 99.9%, and the low resistance sheathing was formed from silver having a purity exceeding approximately 99.9%. The high temperature wire was found to have adequate or superior mechanical, chemical, and electrical properties for usage within high temperature environments of the type described above. In particular, the high temperature wire was found to have excellent tensile strength, as provided by the nickel core. Furthermore, the silver sheathing was found to provide an adequately low electrical resistance; that is, an electrical resistance greater than a comparable wire formed entirely from silver, but significantly less than a comparable wire formed entirely from nickel. The silver sheathing was also found to promote bonding and lasting adhesion of the high temperature dielectric coating. Finally, the high temperature wire was found to have excellent flexibility.

While multiple exemplary embodiments have been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. An oxidation-resistant high temperature wire, comprising:
an elongated core formed from a first material;
an electrically conductive sheathing disposed around the elongated core and formed from a second material, the second material having an electrical conductivity greater than the electrical conductivity of the first material, the first material having a tensile strength greater than the tensile strength of the second material; and
a high temperature dielectric coating formed around the electrically conductive sheathing.

2. An oxidation-resistance high temperature wire according to claim 1 wherein the second material has an electrical conductivity at least twice the electrical conductivity of the first material.

3. An oxidation-resistant high temperature wire according to claim 2 wherein the first material has a tensile strength at least twice the tensile strength of the second material.

4. An oxidation-resistant high temperature wire according to claim 1 wherein the elongated core comprises nickel having a purity greater than approximately 99.9%.

5. An oxidation-resistant high temperature wire according to claim 1 wherein the electrically conductive sheathing has an outer oxidized surface, and wherein high temperature dielectric coating is formed in adherence with the outer oxidized surface.

6. An oxidation-resistant high temperature wire according to claim 1 wherein the second material has a magnetic susceptibility between approximately −19.5×10⁻⁶ and approximately −5.46×10⁻⁶ centimeter-gram-second.

7. An oxidation-resistant high temperature wire according to claim 1 wherein the first material has a tensile strength greater than approximately 800 megapascal.

8. An oxidation-resistant high temperature wire according to claim 1 wherein the elongated core comprises platinum.

9. An oxidation-resistant high temperature wire according claim 4 wherein the second material is selected from the group consisting of silver and gold.

10. An oxidation-resistant high temperature wire according to claim 9 wherein the second material comprises silver having a purity exceeding approximately 99.9%.

11. An oxidation-resistant high temperature wire according to claim 9 wherein the second material comprises gold, and wherein the oxidation-resistant high temperature wire further comprises an adhesion layer formed between the electrically conductive sheathing and the high temperature dielectric coating.

12. An oxidation-resistant high temperature wire according to claim 11 wherein the adhesion layer comprises at least one of the group consisting of silver, platinum, nickel, and aluminum.

13. An oxidation-resistant high temperature wire according to claim 1 wherein the high temperature dielectric coating comprises:
an organic binder;
a dielectric material; and
an inorganic lubricant selected from the group consisting of aluminum nitride, silicon nitride, titanium nitride, and boron nitride.

14. An oxidation-resistant high temperature wire according to claim 13 wherein the inorganic lubricant comprises approximately 10% to 0.01% boron nitride, by weight of the dielectric material.

15. An oxidation-resistant high temperature wire, comprising:
an elongated core formed from nickel having a purity greater than approximately 99.9%;
an electrically conductive sheathing formed from silver having a purity greater than approximately 99.9%, the electrically conductive sheathing having an outer oxidized surface; and
a high temperature dielectric coating formed around the electrically conductive sheathing in adherence with the outer oxidized surface.

16. An oxidation-resistant high temperature wire according to claim 15 wherein the high temperature dielectric coating comprises boron nitride.

17. A method for manufacturing an oxidation-resistant high temperature wire, the method comprising the steps of:
forming an elongated core from a first material;
forming an electrically conductive sheathing from a second material around the elongated core; and
applying a high temperature dielectric coating around the electrically conductive sheathing;
wherein the second material has an electrical conductivity greater than the electrical conductivity of the first material, and wherein the first material has a tensile strength greater than the tensile strength of the second material.

18. A method according to claim 17 wherein the second material an electrical conductivity at least twice the electrical conductivity of the first material, and wherein the first material has a tensile strength at least twice the tensile strength of the second material.

19. A method according to claim 18 further comprising the step of oxidizing the electrically conductive sheathing to create an outer adhesion surface, the step of oxidizing performed prior to the step of forming a high temperature dielectric coating.

20. A method according to claim 19 wherein the step of forming an elongated core comprises forming an elongated core from a nickel having a purity greater than approximately 99.9%, and wherein the step of forming an electrically conductive sheathing comprises forming an electrically conductive sheathing from a silver having a purity greater than approximately 99.9%.
